(19) United States
(12) Patent Application Publication
(10) Pub. No.: US 2017/0096857 A1
(43) Pub. Date: Apr. 6, 2017

(54) Combination of two safety attachments for ladders.

(71) Applicant: Bobby Park, Fairlie (GB)

(72) Inventor: Bobby Park, Fairlie (GB)

(21) Appl. No.: 14/876,559

(22) Filed: Oct. 6, 2015

(51) Int. Cl. E06C 7/48

(52) U.S. Cl. CPC E06C 7/48

(57) ABSTRACT

A combination of two safety attachments for ladders which incorporates two interchangeable gliding sections, a left hand and a right hand non gliding section, deformable materials, and rod and anti distortion flanged tubes to eliminate distortion and waggling between the assemblies of the gliding sections and non gliding sections. Also incorporated would be two rocking sections and thumb nuts or similar, all having the ability to be married to the upright channel or box section structure of a ladder and characterised by their ability to improve the safety of the ladder by converging and partly sleeving the upright channel or box sections of a ladder and to take a part form of, or partly contour, the surface to which they are set upon or against.

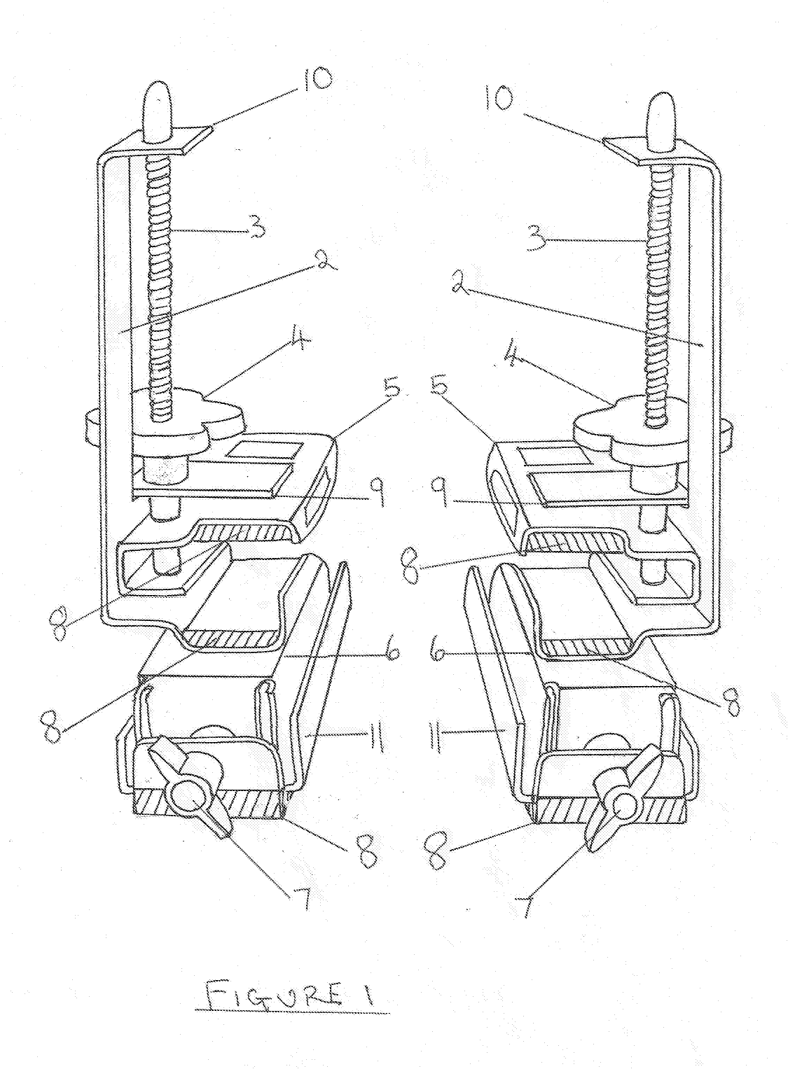

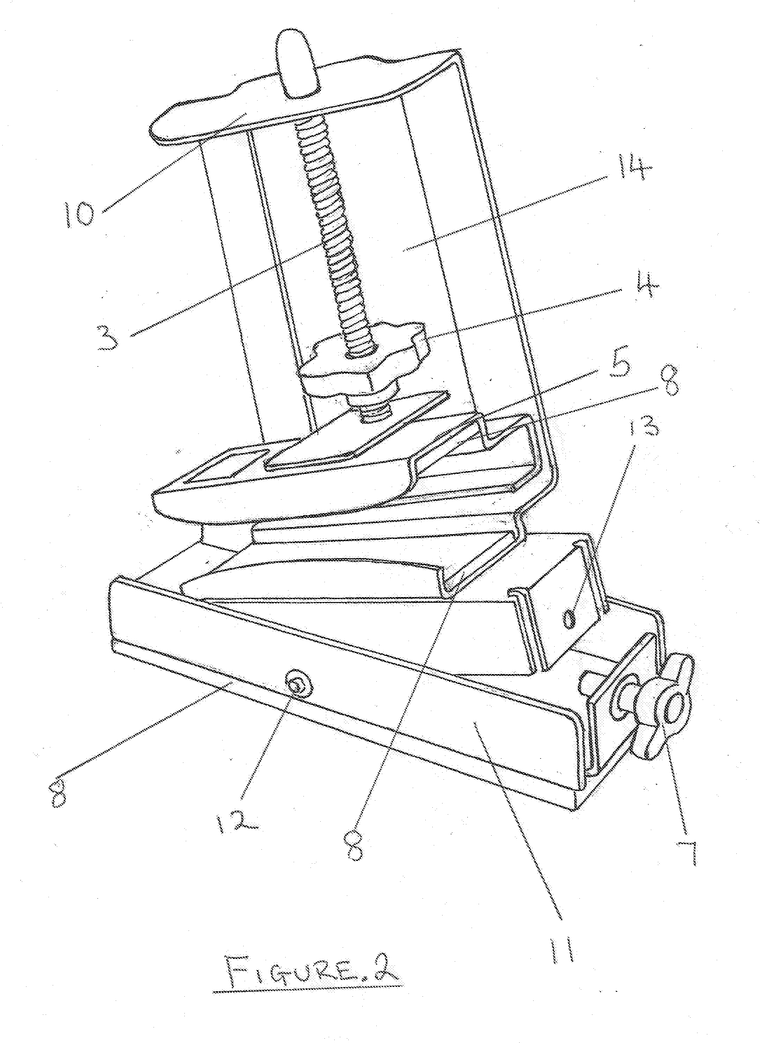

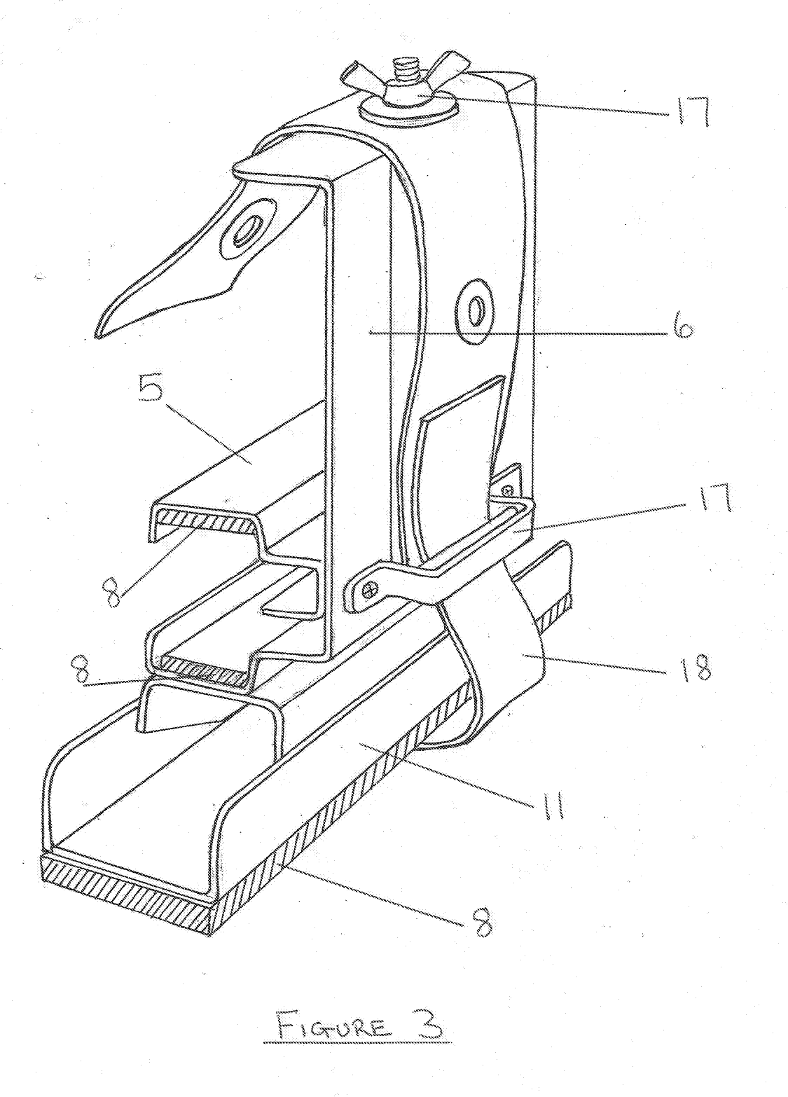

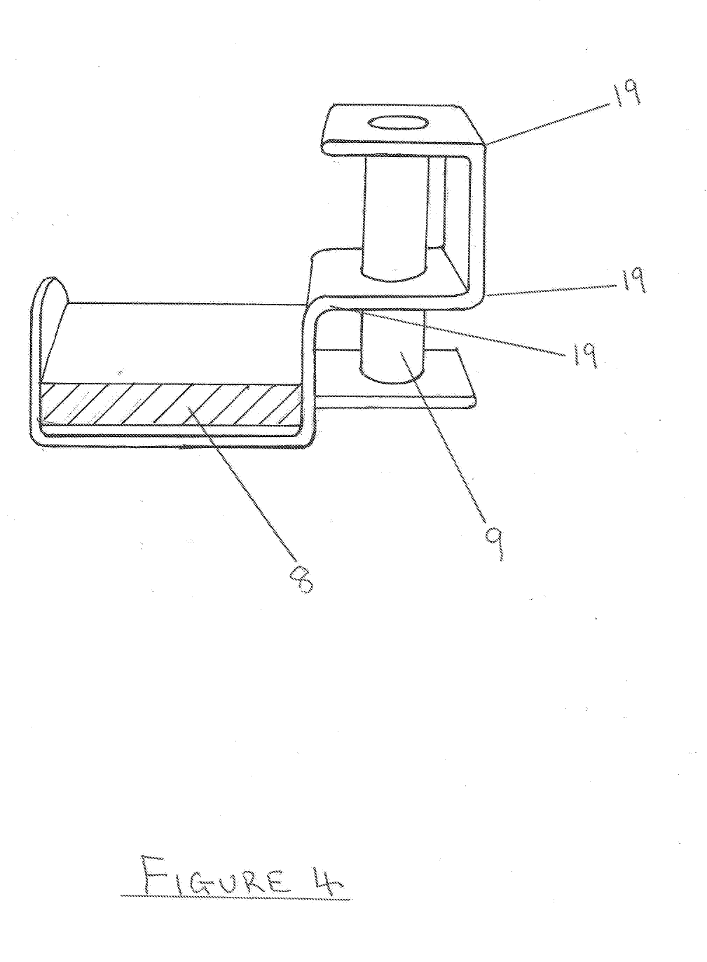

The present invention relates to a combination of two safety attachments for ladders (FIG. 1, section 2) converging jointly with the upright channel or box sections of a ladder. The safety attachments preferably consisting of two non-gliding sections (FIGS. 1 and 3, section 6) and two interchangeable gliding sections (FIGS. 1, 2 and 3, section 5) preferably having the ability to partly sleeve at least three sides of the upright channel or box-like structure of a ladder. This will be achieved by exerting force against an anti-distortion flanged tube on a gliding section (FIGS. 1 and 4, section 9) having a strengthening configuration (FIG. 4, section 19). A rod arrangement on the non gliding sections of the attachments (FIGS. 1 and 2, section 3), combined with the anti-distortion flanged tube (FIGS. 1 and 4, section 9), will provide a gliding arrangement for the gliding sections of the attachments and will prevent ‘waggle’ between the gliding sections and non gliding sections. The flanged tube and general strengthening configuration of the gliding sections have been designed to prevent any distortion or unwanted ‘waggling’ of, or between, the gliding sections and non gliding sections. I he attachments would preferably have deformable materials (FIGS. 1, 2, 3 and 4, section 8) on their inner and outer faces, all being for the purpose of making ladders more secure and safer in general. In particular the attachments will allow any part of a ladder stile to be rested against a range of surfaces such as scaffolding bars, UPVC window sills, metal or UPVC guttering, smooth or rough walls, the edging of flat roofs, metal facings on metal buildings, etc and will give greater stability to the ladder.

The safety attachments would each preferably facilitate rocking sections (FIGS. 2 and 3, section 11) with a deformable material on one or more of their outer faces, a screwed rod (FIGS. 1 and 2, section 3), thumb nut or quick release trigger mechanism (FIGS. 1 and 2, section 4), a latching mechanism (FIGS. 1 and 2, section 7) and a pintle (FIG. 2, section 12), all to improve the safety of ladders. Also the ladder safety attachments would preferably include a means of enabling a ‘utility pole’ strap (FIG. 3, section 18) to be connected to them (FIG. 4, section 17).

A further objective of the new invention would be that when the gliding sections and non gliding sections converge with the upright channel or box sections of a ladder and partly sleeve each of the upright sections of a ladder, the detormable materials on their inside faces (figures1, 2 and 3, section 8) will provide a cushioning and gripping action at the safety attachments resting point on the ladder. It would essentially be that the non gliding sections of the safety attachments were specifically manufactured as a pair, one for the left hand side of a ladder and one for the right hand side of a ladder.

It would also be desirable that the safety attachments could be positioned at any location along the longitudinal length of a ladder's upright channel or box section, thus being adaptable to rest against the angle-pitch of a roof gable. It would be preferred that the rocking section of each attachment would be provided with a securing means to make it stable, allowing the rocking section to lie parallel and stable relative to the ladder upright channel or box section to which it is fitted. This would allow the user to set a ladder against a sharp edge without fear of the rocking sections rocking inadvertently, thus allowing the deformable material on the rocking section (FIG. 2, section 11) to take the partial form of, or partly contour, the surface against which it rests. This will provide the ladder and attachments with a gripping effect and in turn make the ladder more secure from its top to its bottom by providing it with improved downward and sideways grip and stability. The unique configuration and design of the attachments allow them to be fitted to either the fly sections or base sections of most extension ladder upright sections, even when the ladder is closed together. It is preferred that both non gliding sections would include a rod retaining arrangement (FIGS. 1 and 2, section 10) and aperture (FIG. 2, section 14) to accommodate the movement of the thumb nuts (FIGS. 1 and 2, sections 4).

### BACKGROUND TO THE INVENTION

Most ladders are now made of aluminium or fibreglass and, although generally fitted with feet and top pads, there is lithe or no means of improving ladder stability between those two points and therefore there is no stability when this area of the ladder is landed on a surface.

A number of accessories and safety features are available to improve stability at the top and bottom of ladders when positioned against a work surface but very few are available to improve stability at other points on the ladder.

None of the ladder attachments currently available combine the unique configuration of a gliding section with anti distortion flanged tube and a rod for glide control and anti waggle control. This combination is fundamental to the practical operation of the ladder safety attachments described here.

### EXAMPLES

1. GB2348235 A would need manual strength to connect to the ladder rail and so would not be convenient for use by weaker persons.

2. Trial and error with US 2002/0134619 A1 has concluded that the design would suffer distortion to the configurations when tightened and they would also suffer from severe waggle between the two sections. There is also no provision of a deformable material to rest on. Neither could this example be fitted to the base section of an extension ladder when both base section and fly sections of the ladder were together.

3. U.S. Pat. No. 3,486,580 P cannot adjust to different ladder rail sizes, nor can it be fitted to the fly or base sections of an extension ladder when the fly and base sections were stored together. It would be awkward to attach and would not pass the rungs of the ladder without having to be unattached. It would not provide the ladder with a deformable material to rest on, or against, and would also take a great deal of time to assemble and setup for use, and therefore be unlikely be used routinely by the majority of ladder users.

### THE PROBLEM ADDRESSED BY THE PRESENT INVENTION

Approximately 43% of fatal falls in the last decade have involved a ladder. Among construction workers an estimated 81% of fall injuries treated in U.S. emergency departments involve a ladder. In 2011, work-related ladder fall injuries resulted in 113 fatalities and an estimated 15,460 reported non fatal fall injuries involving ladders resulted in absence from work for at least 1 day. The limitations of existing patents and safety devices on the market suggest that this problem has not yet been solved and urgently needs to be addressed.

It is therefore desirable to improve ladder safety and, to encourage this, it is important to provide ladder safety attachments which are small, lightweight, versatile, non complex, affordable, easily stored, simple to use and can be fitted to virtually any ladder, providing greater stability by using deformable materials which would deform to the shape of the contact surface, giving improved sideways and downward grip and making the ladder safer to climb.

The present invention can be easily fitted to either the fly section or the base section of most extension ladders, even when they are stored together. It reduces both sideways and downward slippage of a ladder resting against a range of surfaces and will reduce the number of fatal falls and accidents involving ladders.

### DETAILED DESCRIPTION OF PREFERRED EMBODIMENTS

Referring now in more detail and by reference to the drawings which illustrate several practical embodiments of the present invention.

Referring to FIG. 1 a combination of two safety attachments for ladders in accordance with the embodiments of the present invention, each comprising a rod 3, thumb nut 4, gliding section 5, non-gliding section 6, latching arrangement 7, deformable material 8, an anti distortion flanged tube 9 and a rod retaining section 10.

Referring to FIG. 2 a right handed safety attachment for ladders in accordance with the embodiments of the present invention comprising a rocking section 11, pintal 12, latch keeper 13, aperture for thumb nut 14, deformable material 8, gliding section 5, rod retaining section 10, rod 3, thumb nut 4 and latching arrangement 7.

Referring to FIG. 3 a safety attachment for ladders in accordance with the embodiments of the present invention, comprising attachments for a utility pole strap 17, a section of utility pole strap 18, rocking section 11, deformable material 8, gliding section 5 and non-gliding section 6.

Referring to FIG. 4 an exploded view of a gliding section 5 of the combination of two safety attachments for ladders in accordance with the embodiments of the present invention comprising of strengthening configurations 19, anti-distortion flanged tube 9 and deformable material 8.

1. A combination of two safety attachments for ladders, each converging jointly with the upright channel or box sections of a ladder and collectively consisting of two non gliding sections and two gliding sections. The non gliding sections essentially being a pair, one being left handed and one being right handed, and the gliding sections having been constructed to engage with the non-gliding sections. Each gliding section combining an anti-distortion flanged tube and each non gliding section having a rod affixed. The rod and anti-distortion flanged tube configuration being constructed to engage with each other. Further, each non-gliding section being provided with a keeper and having a means to engage with a rocking section. Each gliding and non-gliding section having a configuration enabling it to partly be filled by at least three faces of a channel or box like configuration or structure.

2. According to claim 1 where each gliding section being provided with a deformable material on their inner faces.

3. According to claim 1 where the non-gliding sections would be provided with a screwed rod to engage with the gliding sections anti-distortion flanged tube.

4. According to claim 1 where the non-gliding sections would be provided with a deformable material on their inner faces.

5. According to claims 1 or 3 where the non-gliding sections preferably consist of a configuration so as to partly sleeve three sides of a box like or channel configuration.

6. According to claims 2 and 3 where the gliding sections and non-gliding sections would consist of a configuration so as to partly sleeve at least three sides of a box like or channel configuration.

7. According to one or more of the above claims where the rod would include of a thumb nut to position the gliding section.

8. According to one or more of the above claims where each non-gliding section would be fitted with a rocking section.

9. According to one or more of the above claims where the non-gliding section would provide a facility to attach a utility pole strap.

10. According to one or more of the above claims where the rocking sections could be interchangeable with both left hand and right hand non-gliding sections.

11. According to all above claims where the rocking section would be provided with a deformable material on at least one of its outer taces.

12. According to clams 1, 10 and 11 where the rocking section would include a securing means to engage with a keeper on the non-gliding section.

13. According to clams 1, 11 and 12 where the rocking section would be provided with a pintal.

14. According to one or more of the above claims where the non-gliding section being provided with a pintal.

15. According to claim 1 where the gliding sections and non-gliding sections combined having the capability to partly sleeve the sides of the two channels or the box configurations of a ladder's upright sections.

16. According to one or more of the above claims where the rod would have a quick release trigger mechanism related with it.

17. According to one or more of the above claims where the rocking section would provide a facility to attach a utility pole strap.

18. According to claim 4 where the gliding section would be interchangeable with both left hand and right hand non-gliding sections.
